(19) United States
(12) Patent Application Publication
(10) Pub. No.: US 2026/0002557 A1
(43) Pub. Date: Jan. 1, 2026

(54) Tolerance Compensation Device and Tolerance Compensation Assembly

(71) Applicant: Illinois Tool Works Inc., Glenview, IL (US)

(72) Inventors: Ruirui Wu, Shanghai (CN); Zhilin Li, Shanghai (CN); Jiahui He, Shanghai (CN)

(21) Appl. No.: 19/252,059

(22) Filed: Jun. 27, 2025

(30) Foreign Application Priority Data
Jun. 28, 2024 (CN) 202410864841.0
Jun. 26, 2025 (CN) 202510868807.5

(51) Int. Cl. F16B 5/02

(52) U.S. Cl. CPC F16B 5/0258

(57) ABSTRACT

A tolerance compensation device including a first compensation member having a sleeve and a bottom seat arranged around one end of the sleeve, the sleeve defining a receiving passage; and a second compensation member including a base portion and an elastic clamping portion connected to the base portion, the base portion defining an aperture. The sleeve of the first compensation member is detachably connected at its other end to the base portion of the second compensation member, with the receiving passage aligned with the aperture. The elastic clamping portion of the second compensation member cooperates with the bottom seat of the first compensation member to clamp a first component (e.g., a vehicle chassis guard plate) therebetween. By employing this tolerance compensation device when connecting the first component to a second component (e.g., a vehicle subframe), the device compensates for displacement tolerances generated between the second component and the first component during vehicle operation, thereby preventing the first component from moving with the second component.

### RELATED APPLICATIONS

The present application claims the benefit of Chinese Patent Application Nos. 202410864841.0, filed Jun. 28, 2024 titled “Tolerance Adjuster For Vehicle Chassis Guard Plates”, and 202510868807.5, filed Jun. 26, 2025 titled “Tolerance Compensation Device and Tolerance Compensation Assembly,” the contents of which are hereby incorporated by reference.

### TECHNICAL FIELD

The present application relates to the technical field of vehicle component assembly, and in particular, to a tolerance compensation device and a tolerance compensation assembly comprising the same.

### BACKGROUND

In conventional technologies, to protect exposed components on a vehicle chassis, a chassis guard plate is typically installed on the chassis to prevent scraping between the chassis components and the ground, thereby avoiding structural damage to the chassis-mounted parts. Additionally, the chassis guard plate contributes to reducing aerodynamic drag. For electric vehicles, which prioritize low drag and energy efficiency, the guard plate further functions as a flow-disrupting member, thereby enhancing the driving range of electric vehicles. Generally, connecting members are employed to facilitate quick and convenient installation of the chassis guard plate onto the vehicle chassis while ensuring a secure and fixed positional relationship between the guard plate and the vehicle body.

### SUMMARY

The present disclosure relates generally to a tolerance compensation device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is an exploded view of a tolerance compensation device according to one embodiment of the present application and a first component connected thereto.

FIG. 2A is a perspective view of the first compensation member shown in FIG. 1.

FIG. 2B is a side view of the first compensation member shown in FIG. 2A.

FIG. 2C is a top view of the first compensation member shown in FIG. 2A.

FIG. 3A is a top view of the second compensation member shown in FIG. 1.

FIG. 3B is a side view of the second compensation member shown in FIG. 3A.

FIG. 3C is a perspective view of the second compensation member shown in FIG. 3A.

FIG. 4A is a top view of the isolation member shown in FIG. 1.

FIG. 4B is a side view of the isolation member shown in FIG. 4A.

FIG. 4C is a perspective view of the isolation member shown in FIG. 4A.

FIG. 5A is a top perspective view of a pre-assembled unit comprising the first compensation member and isolation member from FIG. 1.

FIG. 5B is a bottom perspective view of the pre-assembled unit comprising the first compensation member and isolation member from FIG. 1.

FIG. 6A is a bottom perspective view of the first component shown in FIG. 1.

FIG. 6B is a perspective view showing the pre-assembled unit from FIG. 5A installed in the first component.

FIG. 6C is a perspective view showing the second compensation member from FIG. 1 assembled to the pre-assembled unit in FIG. 6B.

FIG. 6D is an axial cross-sectional view of FIG. 6C.

FIG. 7 is an axial cross-sectional view showing the tolerance compensation device from FIG. 6C cooperating with a bolt to connect the first component and a second component.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Through extensive observation and research, it has been identified that with the development of new energy vehicles, large-capacity battery packs occupy an increasingly significant space within the vehicle chassis. Consequently, in certain scenarios, there is insufficient space on the chassis to securely mount the chassis guard plate, necessitating the attachment of a portion of the guard plate to the subframe for fixation. However, since the vehicle subframe undergoes relative displacement with respect to the vehicle body during operation, conventional connecting or fastening mechanisms that link the subframe to the chassis guard plate transmit this motion to the guard plate. This fails to maintain a fixed positional relationship between the guard plate and the vehicle body, potentially exposing chassis components beyond the guard plate's coverage and leading to damage.

To at least partially address the aforementioned technical challenges, according to one aspect of the present disclosure, the present disclosure provides a tolerance compensation device, the tolerance compensation device includes: a first compensation member including a sleeve and a bottom seat arranged around one end of the sleeve, the sleeve defining a receiving passage; and a second compensation member including a base portion and an elastic clamping portion connected to the base portion, the base portion defining an aperture. The sleeve of the first compensation member is detachably connected at its other end to the base portion of the second compensation member, with the receiving passage aligned with the aperture. The elastic clamping portion of the second compensation member cooperates with the bottom seat of the first compensation member to clamp a first component to be connected by the tolerance compensation device therebetween.

In some embodiments, the tolerance compensation device further includes an isolation member including an isolation portion disposed at a side of the bottom seat of the first compensation member facing the second compensation member.

In some embodiments, the isolation portion includes a receiving hole through which the sleeve of the first compensation member passes. The isolation member further includes a first snap-fit connection structure provided on the isolation portion, and the first snap-fit connection structure engages with an edge portion of the bottom seat of the first compensation member to detachably connect the bottom seat to the isolation member.

In some embodiments, the isolation member further includes an anti-rotation protrusion provided on the isolation portion. The edge portion of the bottom seat of the first compensation member is provided with a notch that receives the anti-rotation protrusion to restrict relative rotation between the isolation member and the first compensation member.

In some embodiments, the second compensation member further includes a second snap-fit connection structure provided at the aperture of the base portion. The sleeve of the first compensation member is provided with a flange at its other end, and the flange engages with the second snap-fit connection structure to detachably connect the sleeve to the base portion.

In some embodiments, the second snap-fit connection structure includes a plurality of cantilevered snap hooks arranged around the sleeve.

In some embodiments, the second compensation member further includes a plurality of guide portions provided at the aperture of the base portion. The plurality of guide portions are arranged around the sleeve, and each of the guide portions has a guide inclined surface.

In some embodiments, the second compensation member includes a plurality of elastic clamping portions arranged around the base portion, and each of the elastic clamping portions extends obliquely relative to the base portion and is deflectable relative to the base portion.

In some embodiments, the second compensation member is substantially frustoconical. A central flat portion of the second compensation member forms the base portion, and a peripheral portion is divided to form the plurality of elastic clamping portions.

In some embodiments, the first compensation member is made of a metallic material, and the second compensation member and the isolation member are made of a non-rigid material.

According to another aspect of the present disclosure, the present disclosure provides a tolerance compensation assembly. The tolerance compensation assembly comprises: a first component; a second component; and the aforementioned tolerance compensation device. The first component is clamped between the elastic clamping portion of the second compensation member and the bottom seat of the first compensation member. The base portion and elastic clamping portion of the second compensation member are positioned between the first component and the second component, and accommodate variations in the gap between the first component and the second component through elastic deformation of the elastic clamping portion.

In some embodiments, the tolerance compensation assembly further includes a fastener, and the fastener is inserted into a hole of the second component via the receiving passage and the aperture.

The present application utilizes the tolerance compensation device to connect a first component (e.g., a vehicle chassis guard plate) to a second component (e.g., a vehicle subframe), while compensating for displacement tolerances generated between the second component and the first component during vehicle operation, thereby preventing the first component from moving with the second component.

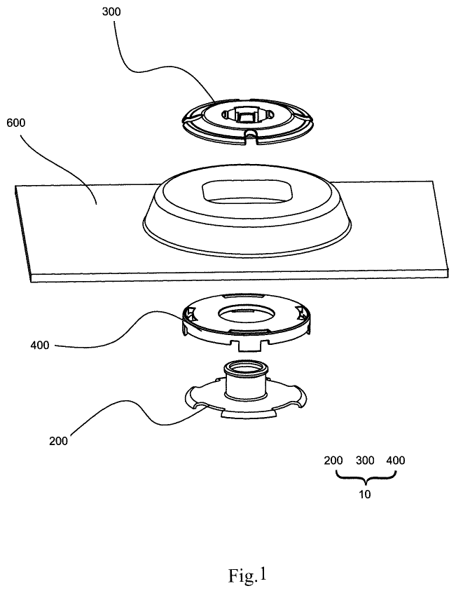

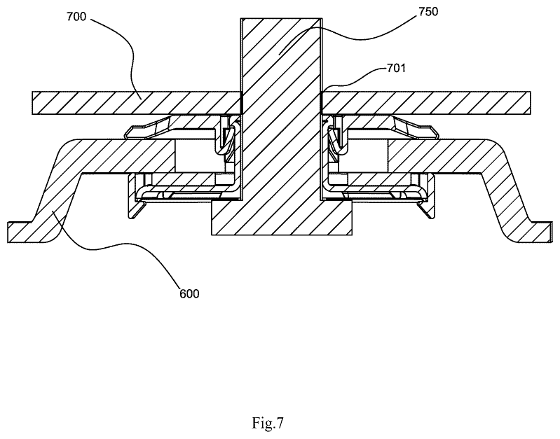

FIG. 1 is an exploded view of the tolerance compensation device 10 according to an embodiment of the present application and the first component 600 connected thereto. The tolerance compensation device 10 is used in cooperation with a fastener such as a bolt to connect the first component 600 to a second component 700 see FIG. 7. The first component 600 is for example a vehicle chassis guard plate, and the second component 700 is for example a vehicle subframe. The first component 600 may be made of metal or non-metal materials.

As shown in FIG. 1, in one embodiment of the present application, the tolerance compensation device 10 comprises a first compensation member 200, a second compensation member 300, and an isolation member 400. The first compensation member 200 is made of, for example, a metal material. The first compensation member 200 is configured to accommodate a bolt for connecting the first component 600 to a corresponding threaded hole provided on the second component 700 via the bolt. It should be noted that whether the isolation member 400 is required may be determined based on the material of the first component 600. For instance, when the first component 600 is made of a non-metal material, the isolation member 400 is made of a non-rigid wear-resistant material (such as plastic) and arranged to abut against one side surface of the first component 600. The isolation member 400 isolates the first compensation member 200 from the first component 600 to prevent significant friction and consequent wear on the first component 600 that would otherwise occur due to direct contact between the first compensation member 200 and the first component 600 when relative displacement occurs between the tolerance compensation device 10 and the first component 600 in horizontal directions (X- and Y-axis directions). The second compensation member 300 is made of an elastic non-rigid material (such as plastic) and arranged to abut against the opposite side surface of the first component 600. The second compensation member 300 is configured to, when relative displacement occurs between the tolerance compensation device 10 and the first component 600 in the vertical direction (Z-axis direction) under the influence of the second component 700, absorb the force from the second component 700 through its own deformation, thereby preventing movement of the first component 600 caused by the second component 700. When the first component 600 is made of a metal material, the isolation member 400 may be omitted, and the second compensation member 300 may be made of an elastic metal material (such as spring steel). During assembly of the tolerance compensation device 10 to the first component 600, the first compensation member 200 and the isolation member 400 are first assembled together to form a pre-assembled unit. This pre-assembled unit is then installed into the first component 600, followed by installation of the second compensation member 300 onto the pre-assembled unit, thereby forming a tolerance compensation assembly with compensation functionality.

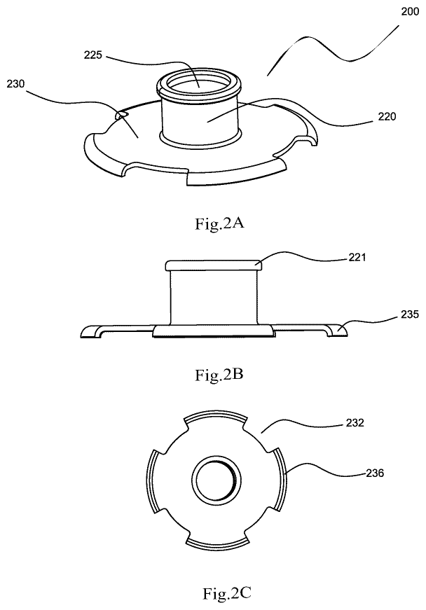

FIGS. 2A to 2C illustrate the specific structure of the first compensation member 200 shown in FIG. 1, which are respectively a perspective view, a side view, and a bottom view of the first compensation member 200.

As shown in FIGS. 2A-2C, in the illustrated embodiment, the first compensation member 200 is an integrally formed metal component comprising a sleeve 220 and a bottom seat 230 disposed around one end of the sleeve 220. The sleeve 220 defines a receiving passage 225 which is substantially cylindrical in shape for receiving a bolt. The bottom seat 230 has a generally circular outer profile. The sleeve 220 is substantially centrally arranged on the bottom seat 230.

As shown in FIGS. 2A and 2B, the sleeve 220 is provided with a flange portion 221 at its other end (i.e., the free end). The flange 221 protrudes outward from the outer surface of the sleeve 220 and extends circumferentially around the sleeve 220. The edge portion 235 of the bottom seat 230 is bent in a direction opposite to the free end of the sleeve 220.

As shown in FIG. 2C, the edge portion 235 of the bottom seat 230 is provided with notches 232 for restricting rotation of the isolation member 400 relative to the first compensation member 200. In the illustrated embodiment, there are four notches 232 uniformly distributed around the sleeve 220. These four notches 232 divide the edge portion 235 of the bottom seat 230 into four spaced edge connection portions 236, through which the bottom seat 230 is detachably connected to the isolation member 400.

Those skilled in the art should understand that the bottom seat 230 may have shapes other than circular, and its edge portion may be provided with any number of notches, which could be either one or multiple.

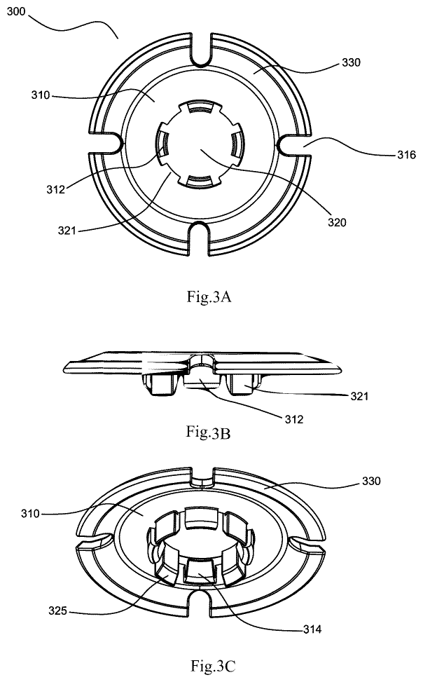

FIGS. 3A to 3C illustrate the specific structure of the second compensation member 300 shown in FIG. 1, presenting a top view, side view, and perspective view of the second compensation member 300 respectively.

As shown in FIGS. 3A-3C, the second compensation member 300 includes a base portion 310 and elastic clamping portions 330 connected to the base portion 310. In the illustrated embodiment, the second compensation member 300 is generally frustoconical in shape, with its central flat portion forming the base portion 310 and its peripheral portion divided by multiple openings 316 to form multiple elastic clamping portions 330. The openings 316 facilitate elastic deformation of the clamping portions 330. While the illustrated embodiment shows four openings, other embodiments may incorporate either more or fewer openings. In some implementations, the elastic clamping portions 330 extend obliquely from the base portion 310 and are deflectable relative to the base portion 310 to enable elastic deformation.

The base portion 310 is provided with a substantially circular aperture 320. At the periphery of the aperture 320, the base portion 310 incorporates both a second snap-fit connection structure 312 and guide portions 321.

The second snap-fit connection structure 312 is configured to engage with the flange 221 on the sleeve 220 of the first compensation member 200, thereby detachably connecting the sleeve 220 to the base portion 310. In the illustrated embodiment, the second snap-fit connection structure 312 comprises multiple cantilevered snap hooks 314 (four shown in the drawings) that extend downward from the base portion 310 and are uniformly arranged along the periphery of the aperture 320 to surround the sleeve 220 when engaged with its flange 221. Alternative embodiments may incorporate either more or fewer cantilevered snap hooks 314 as required.

The guide portions 321 serve to guide the insertion of the sleeve 220 into the aperture 320, ensuring centered alignment within the array of cantilevered snap hooks 314. In the illustrated embodiment, four guide portions 321 are alternately arranged with the cantilevered snap hooks 314 along the periphery of the aperture 320. Alternative implementations may employ either more or fewer guide portions 321. Each guide portion 321 features a guide inclined surface 325 oriented toward the central axis of the aperture 320 (not shown), with at least a portion of the guide inclined surface 325 extending further from the base portion 310 than the distal ends of the cantilevered snap hooks 314.

During installation of the second compensation member 300 onto the pre-assembled unit comprising the first compensation member 200 and isolation member 400, the guide inclined surfaces 325 of the guide portions 321 initially contact the outer wall of the sleeve 220 of the first compensation member 200, directing further insertion of the sleeve 220 into the aperture 320 of the second compensation member 300. Throughout this process, the cantilevered snap hooks 314 first undergo radial deformation when compressed by the flange 221 of the sleeve 220. Upon complete insertion of the sleeve 220 into position, the cantilevered snap hooks 314 elastically rebound to engage with the flange 221, thereby securing the base portion 310 to the sleeve 220.

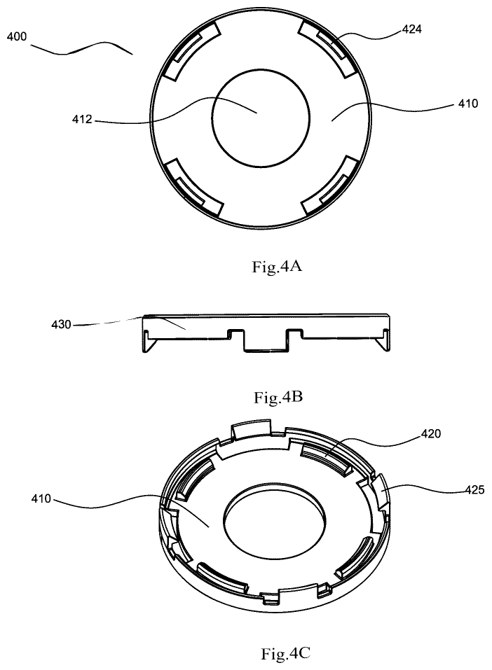

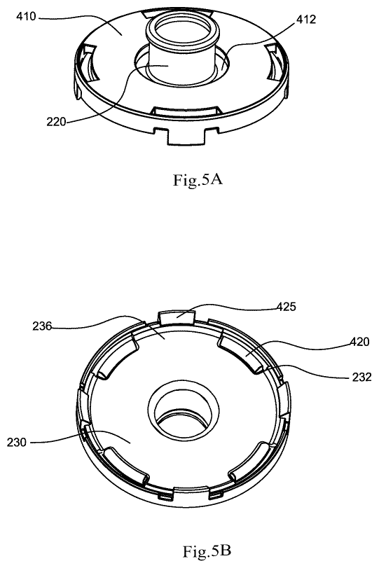

FIGS. 4A to 4C illustrate the specific structure of the isolation member 400 shown in FIG. 1, presenting a top view, side view, and perspective view of the isolation member 400 respectively.

As shown in FIGS. 4A-4C, in the illustrated embodiment, the isolation member 400 is configured as a cover-like structure comprising a substantially circular isolation portion 410 and an annular wall 430 extending from the periphery of the isolation portion 410. The isolation portion 410 is formed with a receiving hole 412 for passage of the sleeve 220 of the first compensation member 200 (shown in FIG. 2A). The isolation member 400 further includes a first snap-fit connection structure 424 disposed on the isolation portion 410, which engages with the edge connection portions 236 of the edge portion 235 of the bottom seat 230 of the first compensation member 200 to detachably connect the bottom seat 230 to the isolation member 400.

In the illustrated embodiment, the first snap-fit connection structure 424 comprises multiple cantilevered snap legs 425 disposed at the periphery of the isolation portion 410 and extending outwardly from the annular wall 430.

The isolation member 400 further includes an anti-rotation protrusion 420 disposed on the isolation portion 410 on the same side as the first snap-fit connection structure 424. The anti-rotation protrusion 420 is configured to be received in the notch 232 of the bottom seat 230 of the first compensation member 200 to prevent relative rotation between the isolation member 400 and the first compensation member 200. In the illustrated embodiment, the anti-rotation protrusion 420 is substantially arc-shaped, with its circumferential extension length matching that of the notch 232. The shown embodiment features four anti-rotation protrusions 420 and four cantilevered snap legs 425 alternately arranged in the circumferential direction. Alternative embodiments may employ either more or fewer anti-rotation protrusions 420 and cantilevered snap legs 425.

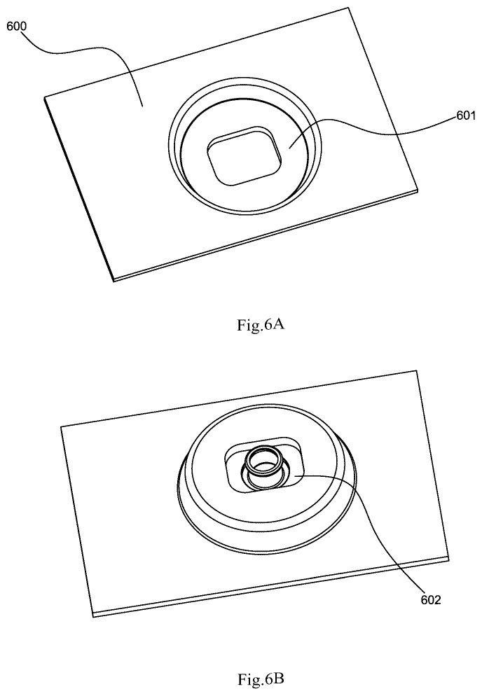

FIGS. 5A and 5B respectively show a top perspective view and a bottom perspective view of the pre-assembled unit comprising the first compensation member 200 and the isolation member 400 from FIG. 1.

As shown in FIGS. 5A and 5B, the receiving hole 412 in the isolation portion 410 of the isolation member 400 has a diameter slightly larger than that of the sleeve 220 of the first compensation member 200, enabling the sleeve 220 to pass through the receiving hole 412. The four spaced notches 232 on the bottom seat 230 of the first compensation member 200 are dimensioned slightly larger than the four anti-rotation protrusions 420 of the isolation member 400, allowing each anti-rotation protrusion 420 to be respectively received within a corresponding notch 232. The edge connection portions 236 of the bottom seat 230 are each engaged by one of the four cantilevered snap legs 425 of the isolation member 400. This configuration maintains relative fixation between the first compensation member 200 and isolation member 400 in both horizontal (X, Y) and rotational directions, while also providing vertical (Z-direction) stability.

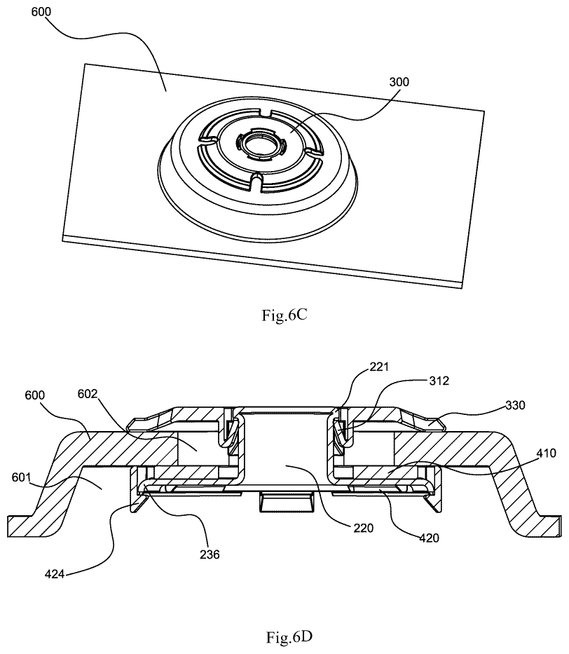

FIG. 6A shows a bottom perspective view of the first component 600 from FIG. 1. FIG. 6B illustrates the pre-assembled unit from FIG. 5A installed in the first component 600. FIG. 6C depicts the second compensation member 300 assembled to the pre-assembled unit shown in FIG. 6B. FIG. 6D presents a cross-sectional view of the assembly shown in FIG. 6C.

As shown in FIGS. 6A and 6B, in the illustrated embodiment, the first component 600 is provided with several mounting recesses 601 (only one shown in the drawings). Each mounting recess 601 is shape-matched with and dimensioned larger than the isolation member 400 to accommodate the pre-assembled unit consisting of the first compensation member 200 and the isolation member 400. The central portion of each mounting recess 601 is formed with a rectangular opening 602 for receiving the sleeve 220 of the first compensation member 200 therethrough. As visible in FIG. 6B, both the length and width of the rectangular opening 602 exceed the diameter of the sleeve 220, permitting horizontal movement of the sleeve 220 within the rectangular opening 602. Those skilled in the art will appreciate that the shape and dimensions of the opening 602 may be designed according to practical requirements, provided the corresponding functionality is maintained.

As shown in FIG. 6C, when the pre-assembled unit comprising the first compensation member 200 and isolation member 400 is in the installed position shown in FIG. 6B, the second compensation member 300 is brought into contact with the outer surface of the mounting recess 601 of the first component 600 and further installed onto the sleeve 220 located in the rectangular opening 602 of the mounting recess 601. This assembly forms the complete tolerance compensation device consisting of the second compensation member 300, first compensation member 200 and isolation member 400, now mounted on the first component 600.

As shown in FIG. 6D, when the tolerance compensation device consisting of the second compensation member 300, the first compensation member 200 and the isolation member 400 is installed on the first component 600, the sleeve 220 of the first compensation member 200 is located in the rectangular opening 602, and the surface of the isolation portion 410 of the isolation member 400 abuts against the inner surface of the mounting recess 601, while the elastic clamping portions 330 of the second compensation member 300 abut against the outer surface of the mounting recess 601. In this state, the first component 600 is clamped in the thickness direction between the elastic clamping portions 330 of the second compensation member 300 and the isolation portion 410 of the isolation member 400. The flange 221 of the sleeve 220 of the first compensation member 200 engages with the second snap-fit connection structure 312 of the second compensation member 300 to maintain relative fixation between the first compensation member 200 and the second compensation member 300. The edge connection portions 236 and the notches 232 of the bottom seat 230 of the first compensation member 200 engage with the first snap-fit connection structure 424 and the anti-rotation protrusions 420 of the isolation member 400 respectively, to maintain relative fixation between the first compensation member 200 and the isolation member 400.

Still as shown in FIG. 6D, the dimensions of the second compensation member 300 and the isolation portion 410 of the isolation member 400 are designed to ensure that when the sleeve 220 of the first compensation member 200 moves within the rectangular opening 602 of the first component 600, the elastic clamping portions 330 of the second compensation member 300 and the surface of the isolation portion 410 of the isolation member 400 can always maintain abutment against the outer surface and inner surface of the mounting recess 601 respectively.

FIG. 7 presents an axial cross-sectional view showing the tolerance compensation device 10 from FIG. 6C cooperating with a bolt 750 to connect the first component 600 to the second component 700. As shown in FIG. 7, the second component 700 is provided with a threaded hole 701 for receiving the bolt 750. The bolt 750 passes through the receiving passage 225 of the sleeve 220 of the first compensation member 200 and the aperture 320 of the second compensation member 300, then engages with the threaded hole 701 on the second component 700, thereby connecting the tolerance compensation device 10 (previously installed on the first component 600 in FIG. 6C) to the second component 700.

Thus, the first component 600 is securely mounted to the second component 700 (e.g., a vehicle subframe) through the combined action of the tolerance compensation device 10 and the bolt 750.

In an exemplary embodiment, the first component is a vehicle chassis guard plate, and the second component 700 is a vehicle subframe. During vehicle operation, the subframe moves relative to the vehicle body in both horizontal and vertical directions, thereby driving the tolerance compensation device to displace relative to the vehicle body in horizontal and vertical directions. Due to the elastic deformability of the elastic clamping portions 330 of the second compensation member 300, the base portion 310 and elastic clamping portions 330 of the second compensation member 300 located between the chassis guard plate and the subframe can adapt to gap variations between the chassis guard plate and the subframe. Therefore, although vertical movement of the subframe will drive the tolerance compensation device to move or deform, it cannot drive the chassis guard plate to move through the tolerance compensation device. In addition, since the assembled tolerance compensation device can move with the sleeve 220 of the first compensation member 200 within the rectangular opening 602 of the first component, although horizontal movement of the subframe will drive the tolerance compensation device to move horizontally, it cannot drive the chassis guard plate to move horizontally through the tolerance compensation device. As a result, the chassis guard plate clamped between the second compensation member 300 and the isolation member 400 remains stationary relative to the vehicle body.

The assembly steps for connecting the first component 600 and the second component 700 using the tolerance compensation device of the present application will be described in detail below:
Step 1: Insert the sleeve 220 of the first compensation member 200 (shown in FIG. 2A) through the receiving hole 412 of the isolation portion 410 of the isolation member 400 (shown in FIG. 4A);
Step 2: Rotate the first compensation member 200 for alignment. When the notches 232 of the bottom seat 230 of the first compensation member 200 are respectively aligned with the anti-rotation protrusions 420 of the isolation portion 410 of the isolation member 400, push the bottom seat 230 further toward the isolation member 400 until the edge connection portions 236 of the bottom seat 230 are engaged and secured by the cantilevered snap legs 425 of the isolation member 400, thereby forming the pre-assembled unit consisting of the first compensation member 200 and isolation member 400 as shown in FIG. 5A;
Step 3: Insert the pre-assembled unit consisting of the first compensation member 200 and the isolation member 400 into the mounting recess 601 provided on the first component 600 as shown in FIG. 6B, so that the sleeve 220 of the first compensation member 200 passes through the rectangular opening 602 on the mounting recess 601, and the surface of the isolation portion 410 of the isolation member 400 abuts against the inner surface of the mounting recess 601;
Step 4: Align the aperture 320 of the base portion 310 of the second compensation member 300 with the sleeve 220 of the first compensation member 200 protruding through the rectangular opening 602, causing the guide portions 321 of the second compensation member 300 to initially contact the sleeve 220 of the first compensation member 200;
Step 5: Further press the second compensation member 300 toward the first component 600, causing the cantilevered snap hooks 314 of the second compensation member 300 to engage the sleeve 220 and be radially compressed to elastically deform until the flange 221 of the sleeve 220 is securely snap-fitted into position. At this stage, the elastic clamping portions 330 of the second compensation member 300 abut against the outer surface of the mounting recess 601 while being capable of elastic deformation in the axial direction. Upon completion of this step, as shown in FIG. 6D, the second compensation member 300, first compensation member 200, and isolation member 400 are fully assembled into a complete tolerance compensation device, with the first component 600 being clamped in the thickness direction between the second compensation member 300 and isolation member 400;
Step 6: Connect the tolerance compensation device 10 installed on the first component 600 in FIG. 6B to the second component 700 using bolt 750, which is accomplished by passing the bolt 750 through the receiving passage 225 of the sleeve 220 of the first compensation member 200 and the aperture 320 of the second compensation member 300, and then screwing it into the threaded hole on the second component 700.

At this stage, the tolerance compensation device consisting of the second compensation member 300, first compensation member 200 and isolation member 400 is fixedly mounted to the vehicle subframe, while the first component 600 can move relative to both the tolerance compensation device and vehicle subframe through its rectangular opening 602. During vehicle operation, the subframe moves relative to the vehicle body in both horizontal and vertical directions, thereby causing corresponding displacement of the tolerance compensation device. Since both the second compensation member 300 and isolation member 400 are made of non-rigid/elastic materials (such as plastic or spring steel), they can elastically deform in horizontal and vertical directions to compensate for subframe movement, thereby maintaining the first component 600 clamped between them in a stationary position relative to the vehicle body.

The tolerance compensation device of the present application enables connection between the first component (e.g., a vehicle chassis guard plate) and the second component (e.g., a vehicle subframe) while compensating for displacement tolerances generated by the second component relative to the first component during vehicle operation, thereby preventing the first component from moving with the second component.

Furthermore, when the first component is made of non-metallic materials, the contact portions of the tolerance compensation device of the present application that interface with the first component employ non-metallic materials (e.g., plastic), thereby reducing wear on the first component and extending its service life.

Additionally, the various components of the tolerance compensation device of the present application utilize snap-fit connection structures, enabling tool-free installation that significantly improves assembly efficiency and convenience, while facilitating component replacement and maintenance.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### REFERENCE NUMERALS

Tolerance compensation device 10
First compensation member 200
Sleeve 220
Flange 221
Receiving passage 225
Bottom seat 230
Notch 232
Edge portion 235
Edge connection portion 236
Second compensation member 300
Base portion 310
Second snap-fit connection structure 312
Cantilevered snap hook 314
Opening 316
Aperture 320
Guide portion 321
Guide inclined surface 325
Elastic clamping portion 330
Isolation member 400
Isolation portion 410
Receiving hole 412
Anti-rotation protrusion 420
First snap-fit connection structure 424
Cantilevered snap leg 425
Annular wall 430
First component 600
Mounting recess 601
Rectangular opening 602
Second component 700
Threaded hole 701
Bolt 750.

What is claimed is:

1. A tolerance compensation device, comprising:
a first compensation member comprising a sleeve and a bottom seat arranged around one end of the sleeve, the sleeve defining a receiving passage; and
a second compensation member comprising a base portion and an elastic clamping portion connected to the base portion, the base portion defining an aperture;
wherein the sleeve of the first compensation member is detachably connected at the other end thereof to the base portion of the second compensation member, with the receiving passage aligned with the aperture; and
wherein the elastic clamping portion of the second compensation member cooperates with the bottom seat of the first compensation member to clamp a first component to be connected by the tolerance compensation device therebetween.

2. The tolerance compensation device according to claim 1, wherein the tolerance compensation device further comprises an isolation member comprising an isolation portion disposed at a side of the bottom seat of the first compensation member facing the second compensation member.

3. The tolerance compensation device according to claim 2,
wherein the isolation portion comprises a receiving hole through which the sleeve of the first compensation member passes; and
wherein the isolation member further comprises a first snap-fit connection structure provided on the isolation portion, the first snap-fit connection structure engaging with an edge portion of the bottom seat of the first compensation member to detachably connect the bottom seat to the isolation member.

4. The tolerance compensation device according to claim 3,
wherein the isolation member further comprises an anti-rotation protrusion provided on the isolation portion; and
wherein the edge portion of the bottom seat of the first compensation member is provided with a notch that receives the anti-rotation protrusion to restrict relative rotation between the isolation member and the first compensation member.

5. The tolerance compensation device according to claim 1,
wherein the second compensation member further comprises a second snap-fit connection structure provided at the aperture of the base portion; and
wherein the sleeve of the first compensation member is provided with a flange at the other end thereof, the flange engaging with the second snap-fit connection structure to detachably connect the sleeve to the base portion.

6. The tolerance compensation device according to claim 5, wherein the second snap-fit connection structure comprises a plurality of cantilevered snap hooks arranged around the sleeve.

7. The tolerance compensation device according to claim 5, wherein the second compensation member further comprises a plurality of guide portions provided at the aperture of the base portion, the plurality of guide portions being arranged around the sleeve, each of the guide portions having a guide inclined surface.

8. The tolerance compensation device according to claim 1, wherein the second compensation member comprises a plurality of the elastic clamping portions arranged around the base portion, each of the elastic clamping portions extending obliquely relative to the base portion and being deflectable relative to the base portion.

9. The tolerance compensation device according to claim 8, wherein the second compensation member is substantially frustoconical, with a central flat portion forming the base portion, and a peripheral portion being divided to form the plurality of elastic clamping portions.

10. The tolerance compensation device according to claim 2,
wherein the first compensation member is made of a metallic material; and
wherein the second compensation member and the isolation member are made of a non-rigid material.

11. A tolerance compensation assembly, comprising:
a first component;
a second component; and
the tolerance compensation device according to claim 1;
wherein the first component (600) is clamped between the elastic clamping portion (330) of the second compensation member (300) and the bottom seat (230) of the first compensation member (200), the base portion (310) and elastic clamping portion (330) of the second compensation member (300) are positioned between the first component (600) and the second component (700), and accommodate variations in the gap between the first component (600) and the second component (700) through elastic deformation of the elastic clamping portion (330).

12. The tolerance compensation assembly according to claim 11,
wherein the tolerance compensation assembly further comprises a fastener; and
wherein the fastener is inserted into a hole of the second component via the receiving passage and the aperture.
